(19) United States
(12) Patent Application Publication
(10) Pub. No.: US 2006/0007358 A1
(43) Pub. Date: Jan. 12, 2006

(54) Display device and control method thereof

(75) Inventor: Joo Won Kim, Goomi-si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/153,625

(22) Filed: Jun. 16, 2005

(30) Foreign Application Priority Data
Jul. 12, 2004 (KR) 54135/2004

(51) Int. Cl. H04N 5/44

(52) U.S. Cl. 348/553; 348/734

(57) ABSTRACT

A processing device includes a receiving unit to receive a program, a video signal processor to process a video signal of the program, and an audio signal processor to process an audio signal of the program. A remoter control or on screen display is used for inputting a user's command. A controller controls the video signal processor and the audio signal processor according to the user's command, so that the video signal and the audio signal are simultaneous adjusted. In an alternate embodiment, the controller automatically adjusts at least one of the video signal and the audio signal based upon a temperature in the environment of the device, genre data associated with the program, or an environment of a scene in the program, as determined by data associated with the program.

This application claims the benefit of the Korean Patent Application No. P2004-054135 filed in Korea on Jul. 12, 2004, which is hereby incorporated by reference.

### BACKGROUND OF THE INVENTION

1. Field of the Invention

The present invention relates to a processing device, and more particularly, to a processing device and a control method thereof, which can set video and/or audio signals. Description of the Related Art

A display is a device for displaying a video signal, and typical examples of the display include a television (TV) and a monitor. The TV selects a broadcasting signal transmitted from a broadcasting station according to a user's selection, and displays the selected broadcasting signal on its screen. The monitor displays a video signal generated at a computer on its screen.

Such displays are gradually being converted from an analog mode to a digital mode with the development of multimedia technology.

Compared with an analog TV, a digital TV provides various additional services, such as a home shopping service, an electronic newspaper service and a stock information service, and provides more broadcasting channels by efficiently using a bandwidth.

A digital TV, in accordance with the related art, will now be described with reference to FIGS. 1 to 3.

FIG. 1 is a block diagram of a related art digital TV. Referring to FIG. 1, the related art digital TV includes a tuner 10 for selecting a broadcasting signal, a demultiplexer (DEMUX) 20 for demultiplexing the selected broadcasting signal into a video signal, an audio signal, and various additional information, a video signal processor 50 for processing the demultiplexed video signal into a video signal displayable on a display unit 60, an audio signal processor 30 for processing the demultiplexed audio signal into an audio signal that can be outputted through a speaker 40, a user interface 70 for inputting a user request command, a controller 80 for outputting a corresponding control signal according to the user request command, and a memory 90 for storing the various additional information from the DEMUX 20.

An operation of the above digital TV will now be described in detail. Referring to FIG. 1, when a user inputs a power-on command and selects a desired channel, the tuner 10 tunes the selected channel. A broadcasting signal received on the tuned channel is inputted into the DEMUX 20 and is divided into a video signal, an-audio signal, and addition information.

The video signal is inputted into the video signal processor 50 and is processed into a video signal displayable on the display unit 60, and the audio signal is inputted into the audio signal processor 30 and is processed into an audio signal-that can be outputted through the speaker 40.

The related art digital TV separately includes a video adjusting means and an audio adjusting means.

FIG. 2 illustrates an OSD (on screen display) menu for adjusting video and audio signals, in accordance with the related art. Referring to FIG. 2, an OSD menu includes a SETUP group, a VIDEO group, an AUDIO group, a TIME group, an OPTION group, and a LOCK group. The VIDEO group includes an EZ Picture item, a Contrast item, a Brightness item, a Color item, a Sharpness item, a Tint item, an XD item, a Color Temperature item, and a Video Preset item, and so on.

A user can control a video signal to be displayed in a desired style by selecting the items of the VIDEO group and adjusting the brightness, contrast, tint and so on of the video signal. Similarly, the user can control an audio signal to be outputted in a desired style by selecting the items of the AUDIO group.

The video and audio signals can be controlled by adjusting items within the OSD menu using a remote controller 80 shown in FIG. 3. The remote controller 80 is an example of the user interface 70 shown in FIG. 1.

In the related art, the video an audio signals of the digital TV are adjusted by selecting specific items of the OSD menu through key buttons formed on the remote controller 80. However, the related art audio/video adjusting method has drawbacks and can be troublesomeness to a user.

Specifically, the related art audio/video adjusting method requires multiple manipulations by the user because separate adjustments of audio/video signals are necessary. Therefore, a typical user is reluctant to separately adjust audio/video signals through the related art method.

For effective viewing, audio/video signals need to be adjusted by a viewer suitably, according to the characteristics of a displayed video program. For example, audio/video signals need to be adjusted suitably according to genres of displayed video programs (such as, a movie, a concert, sports, and so). However, it is inconvenient to the viewer because the viewer must frequently adjust the audio/video signals according to the genre of the video program being viewed.

### SUMMARY OF THE INVENTION

Accordingly, the present invention is directed to a display device and a control method thereof that substantially obviate one or more of the drawbacks due to limitations and disadvantages of the related art.

An object of the present invention is to provide a display device and a control method thereof that makes it possible to simultaneously adjust video/audio signals.

Another object of the present invention is to provide a display device and a control method thereof that make it possible to automatically adjust video/audio signals of a displayed program according to a genre of the program, an environment of a scene in the program, or even the temperature in the room, where the program is being viewed.

Further, another object of the present invention is to provide a display control method that makes it possible to simultaneously adjust video/audio signals through hotkeys installed in a remote controller.

Still another object of the present invention is to provide a display control method that makes it possible to simultaneously adjust video/audio signals through items of an OSD menu.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a processing device includes: a receiver to receive a program; a video signal processor to process a video signal of the program; an audio signal processor to process an audio signal of the program; a user interface to receive a user's command; and a controller to control the video signal processor and the audio signal processor according to the user's command so that both the video signal and the audio signal are adjusted based upon a single user command.

In another aspect of the present invention, a processing device includes: a receiver to receive a program; a video signal processor to process a video signal of the program; an audio signal processor to process an audio signal of the program; a controller to control the video signal processor and the audio signal processor; and a temperature sensor connected to said controller, wherein said controller controls the video signal processor and the audio signal processor according to an output of the temperature sensor so that at least one of the video signal and the audio signal is adjusted.

In another aspect of the present invention, a processing device includes: a receiver to receive a program; a video signal processor to process a video signal of the program; an audio signal processor to process an audio signal of the program; and a controller to control the video signal processor and the audio signal processor, wherein said receiver extracts a genre identification from data information associated with the program, and wherein said controller controls the video signal processor and the audio signal processor according to the genre identification so that at least one of the video signal and the audio signal is adjusted.

In another aspect of the present invention, a processing device includes: a receiver to receive a program; a video signal processor to process a video signal of the program; an audio signal processor to process an audio signal of the program; and a controller to control the video signal processor and the audio signal processor, wherein said receiver extracts information regarding a scene's environment from data information associated with the program, and wherein said controller controls at least one of the video signal processor and the audio signal processor according to the environment of the scene of the program, so that the at least one of the video signal and the audio signal is adjusted.

In further another aspect of the present invention, a method for controlling a processing device includes: simultaneously setting a video output parameter and an audio output parameter to preset adjustment values based upon a single selected item.

It is to be understood that both the foregoing general description and the following detailed description of the present invention are exemplary and explanatory and are intended to, provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a related art digital TV;

FIG. 2 illustrates an OSD menu for setting video and audio signals, in accordance with the related art;

FIG. 3 illustrates a remote controller for controlling an OSD menu, in accordance with the related art;

FIG. 4 is a block diagram of a display according to an embodiment of the present invention;

FIGS. 5 to 8 illustrate OSD menus in a display according to an embodiment of the present invention;

FIG. 8a is an alternative OSD menu to the OSD menu of FIG. 8;

FIG. 9 is a flowchart illustrating a method for setting video and audio factors of menu items according to an embodiment of the present invention;

FIG. 10 is a flowchart illustrating a method for controlling a display according to an embodiment of the present invention; and

FIG. 11 illustrates a remote controller, serving as a user interface of a display, according to an embodiment of the present invention.

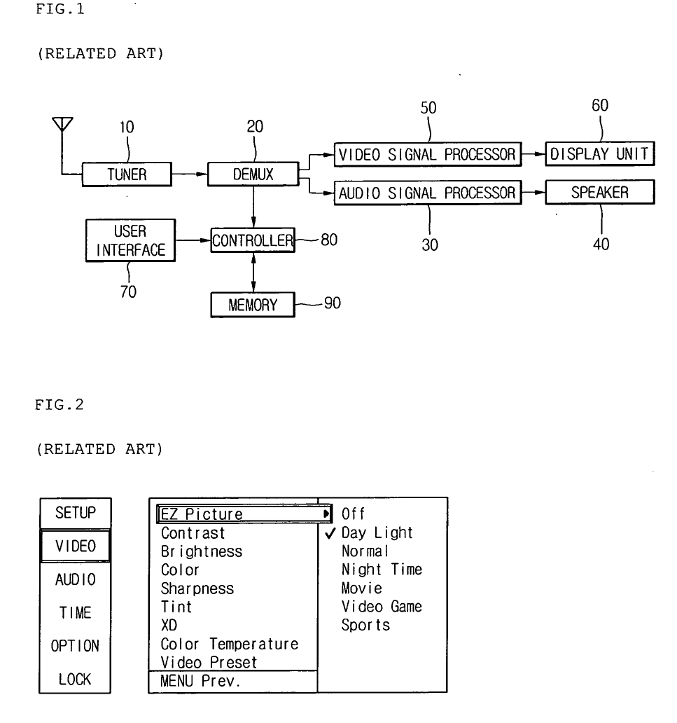

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

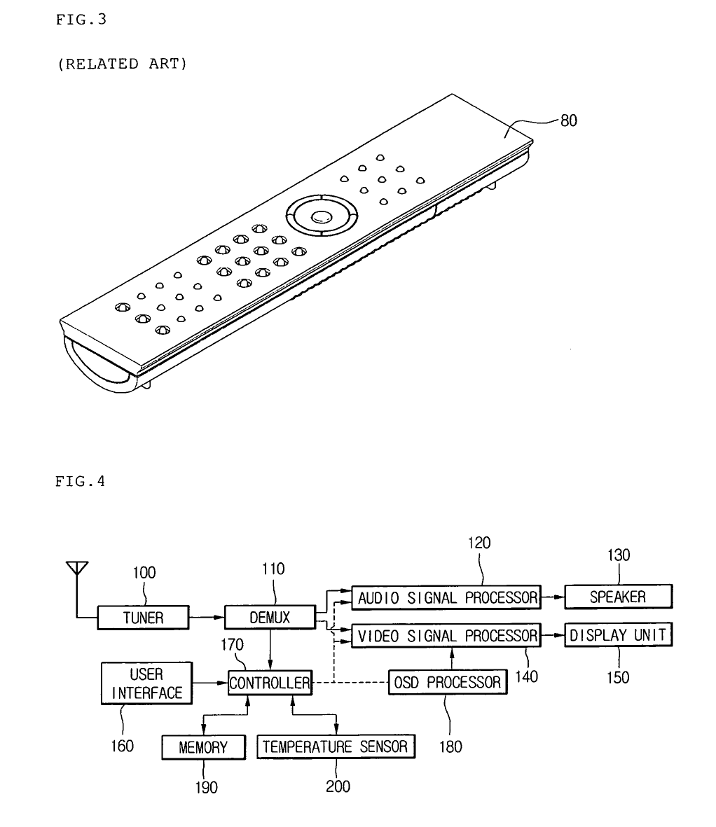

FIG. 4 is a block diagram of a processing device according to an embodiment of-the present invention.

Referring to FIG. 4, an inventive device includes a tuner 100 for selecting a broadcasting signal received through an antenna, a demultiplexer (DEMUX) 110 for demultiplexing the selected broadcasting signal into a video signal, an audio signal, and additional information, a user interface 160 for inputting a user request command, a controller 170 for generating a control signal for simultaneous adjusting video/audio signals according to characteristics of selected video programs when a command for simultaneously adjusting video/audio signals is inputted through the user interface 160, a video signal processor 140 for processing the multiplexed video signal according to the control signal of the controller 170, a display unit 150 for displaying the processed video signal received from the video signal-processor 140, an audio signal processor 120 for processing the multiplexed audio signal according to the control signal of the controller 170, a speaker 130, and an OSD processor 180 for providing an OSD menu. Also, the processing device may further include a memory 190 for storing video programs and various kinds of information.

In the processing device, the controller 170 controls the video signal processor 140 and the audio signal processor 120 in response to the video/audio adjustment command received from the user interface 160, whereby video/audio signals are simultaneously set and outputted according to a user's desire. Specifically, video/audio signals are set and outputted according to characteristics of video programs, whereby effective viewing is possible.

Also, video/audio signals can be set and outputted according to a user's moods. For example, after the user's mood is classified into various categories (such as, angry, board, tired, sad, happy, calm and so on), video/audio signals of a broadcasting program can be set/adjusted and outputted suitably according to the classified mood of the user. That is, in the present invention, video/audio signals are outputted according to video/audio signal modes that are preset suitably for items classified by a specific standard. For example, if the user is calm the bass may be lowered and the picture color elevated. If the user is angry, the picture color can be softened and the volume decreased with a slight increase in bass.

A remote controller 700, shown in FIG. 11, is an example of the user interface 160. The remote controller 700 is equipped with a hotkey input unit 710 for effectively setting video/audio signals according to characteristics of a video program. The hotkey input unit 710 may include a MOVIE key 711, a CONCERT key 712, a SPORTS key 713, a GAME key 714, a NORMAL key 715, and other keys, such as a NEWS key, etc.

Alternatively or additionally, the hotkey input unit 710 may include mood keys, such as Angry, Board, Tired, Sad, Happy, Calm and so on. When a user selects and presses down one of the hotkeys in the hotkey input unit 710, the processing device outputs video/audio signals according to a video/audio signal mode corresponding to the selected hotkey. At this time, the video/audio signal mode corresponding to the selected hotkey is basically preset at the factory, and/or may be later adjusted and stored directly by a user. For example, when a user selects the SPORTS key 713, video/audio signals are outputted according to set video factors (such as contrast, brightness, color, sharpness, tint and the like) and set audio factors (such as balance, treble, bass, subwoofer, 5.1 surround, mono, echo and so on).

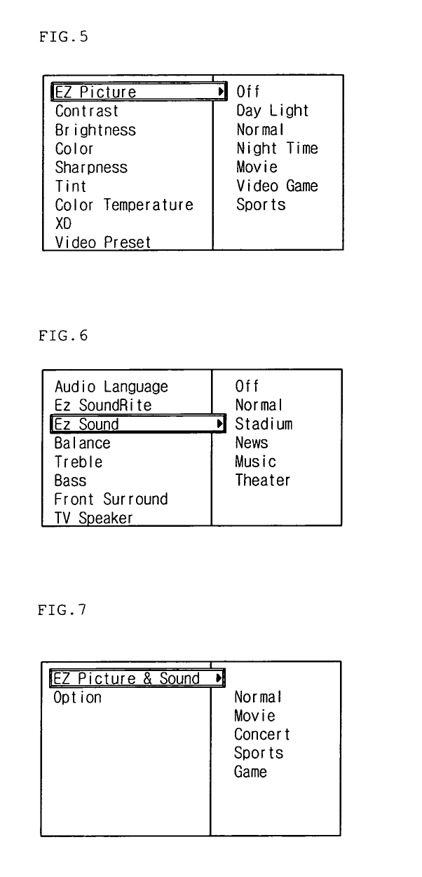

The OSD processor 180 provides an OSD menu for various options including a video/audio signal mode. FIGS. 5 to 8 illustrate OSD menus in a device according to an embodiment of the present invention. In FIGS. 5 and 6, an OSD menu for respectively setting video/audio modes is illustrated. Referring to FIGS. 5 and 6, the OSD menu includes various items for video/audio modes.

First, a user may set items such as Contrast, Brightness, Color, and the like as video settings, or the user may set an EZ Picture item for a more convenient video setting. Also, a user may set items such as Balance, Treble, Bass, and the like as audio settings, or the user may set an EZ Sound item for a more convenient audio setting.

FIG. 7 illustrates an OSD menu for simultaneously setting video/audio modes. Referring to FIG. 7, to simultaneously set video/audio modes, the video/audio modes preferably have a pre-established relationship therebetween, and the video/audio modes are set according to characteristics of a video program.

Specifically; video programs are classified into various genres (such as Movie, Concert, Sports, Video Game, News Normal and the like), and most suitable video/audio modes are set according to corresponding genres. To select one of the Movie, Concert, Sports, Video Game, and Normal modes in the OSD menu, as shown in FIG. 7, the user may highlight and select the mode in the OSD menu, or simply press a corresponding one of the MOVIE key 711, the CONCERT key 712, the SPORTS key 713, the GAME key 714, and the NORMAL key 715 on the remote controller 80, as shown in FIG. 11.

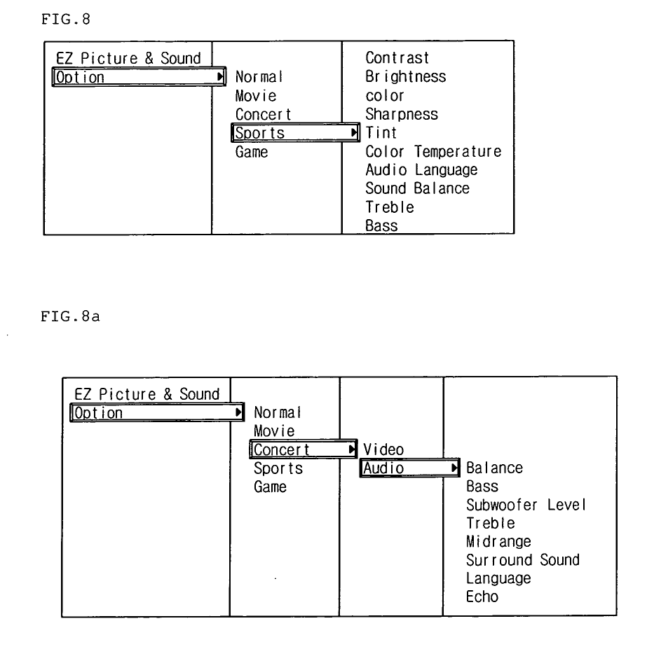

FIG. 8 illustrates an OSD menu for accepting user settings with respect to menu items such as Movie, Concert, Sports, Game, and Normal. As stated above, the menu items (Movie, Concert, Sports, Game, and Normal) each have factory preset video/audio factors, which may be stored in the memory 190. However, when a user is not satisfied with the factory preset video/audio factors, the user can adjust the preset video/audio factors and replace the preset factors with the adjusted factors in the memory 190.

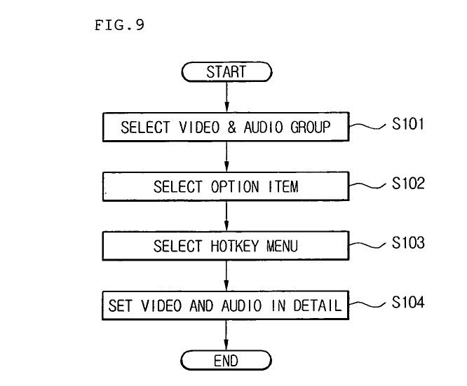

FIG. 9 is a flowchart illustrating a method for setting video and audio factors of menu items according to an embodiment of the present invention. Referring to FIG. 9, a VIDEO & AUDIO group is first selected by a user (S101), and an OSD menu shown in FIG. 8 is then displayed. Here, the VIDEO & AUDIO group (i.e. EZ Picture & Sound) is an example of an upper item of the OSD menu, and may correspond to the VIDEO and AUDIO groups shown in FIG. 2.

If an Option item of the displayed OSD menu is selected by the user (S102), then a screen for selecting one of menu items (such as Movie, Concert, Sports, Game, and Normal) is displayed. Next, an example where a Sport item is selected by the user is illustrated in FIG. 8 (S103).

The selectable items (e.g. Normal, Movie, Concert, Sports, Game) in the menu correspond to the keys of the hotkey input unit 710 shown in FIG. 11.

Once the item (e.g., Sports) is selected, video/audio modes for the selected item are set in detail (S104) and stored in the memory, if the user desires to overwrite the factory presets.

FIG. 8a is an alternative OSD menu similar to FIG. 8. In FIG. 8a, once the user selects the desired genre (e.g. Concert), a next menu asks the user to select between video parameters and audio parameters. By this arrangement, the user may individually select video parameters, and only video settings will be displayed in a next OSD menu (e.g. tint, color, contrast, brightness, etc.). If the user had selected audio parameters, a next OSD menu would have displayed various settable audio parameters (e.g. balance, bass, subwoofer level, treble, etc.).

FIG. 8a differs from FIG. 8 in that the video and audio parameters have separate setting menus. In FIG. 8, the audio and video parameters were displayed together in the menu immediately following the user's selection of the genre.

According to the present invention, video/audio modes can be simultaneously set in the OSD menu and/or by pressing a hotkey. Also, preset video/audio parameters of various genres or moods can be factory preset and subsequentially user adjusted.

An operation of the inventive display will now described in detail. When a user inputs a power-on command through the user interface 160, video/audio signals are outputted according to a preset mode. When desiring to adjust video/audio modes during the viewing of a video program, the user can separately or simultaneously set the video/audio modes through the user interface 160.

The video/audio modes can be simultaneously set through the remote controller 700, shown in FIG. 11, or through the OSD menu shown in FIG. 7. According to video/audio settings classified by characteristics of a video program, video/audio signals are processed respectively by the video signal processor 140 and the audio signal processor 120 and outputted respectively through the display unit 150 and the speaker 130.

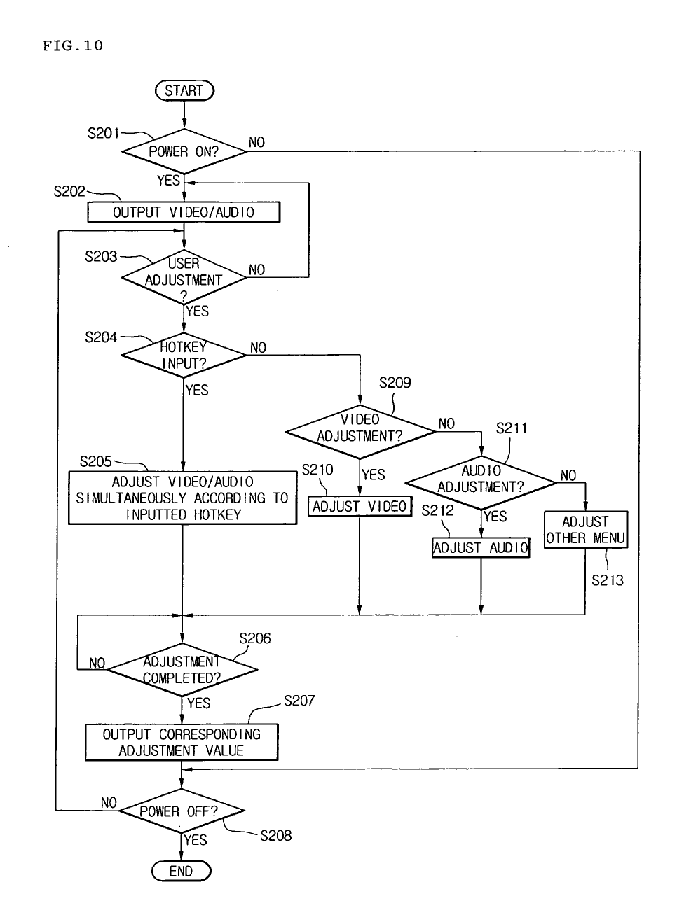

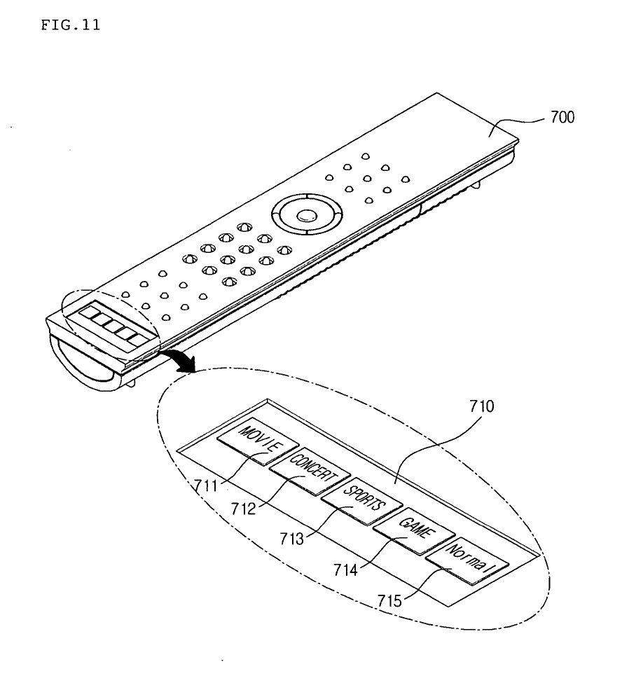

FIG. 10 is a flowchart illustrating a method for controlling a device according to an embodiment of the present invention. Referring to FIG. 10, when a power-on command is first inputted by a user (S201), video/audio signals are outputted according to a preset mode (S202).

The device (specifically, the controller 170) determines whether or not an OSD menu is selected (S203). If the OSD menu is selected (S203), the device determines whether or not a hotkey is inputted (S204). Here, the hotkey is a single input for simultaneously adjusting video/audio signals.

If the hotkey is inputted (S204), the device simultaneously adjusts video/audio signals according to the inputted hotkey (S205). When the adjustment is completed (S206), video/audio signals are outputted according to the adjusted value (S207). When a power-off command is inputted (S208), the control operation is ended.

If the hotkey is not inputted (S204), the device determines whether or not a video adjustment is selected (S209). If the video adjustment is selected (S209), the device adjusts a video signal to a required value (S210) and proceeds to step S206.

If the video adjustment is not selected (S209), the device determines whether or not an audio adjustment is selected (S211). If the audio adjustment is selected (S211), the device adjusts an audio signal to a required value (S212) and proceeds to step S206. If the audio adjustment is not selected (S211), the device performs other required adjustments (S213) and proceeds to step S206.

As stated above, the inventive device and control method thereof makes it possible to simultaneously adjust video/audio signals to an optimal state through items classified according to characteristics of a video program. Also, the inventive device and control method thereof provides a more-simplified user interface, thereby providing convenience and satisfaction to users.

With reference to FIG. 4 an additional embodiment of the present invention will be described. The device may also include a temperature sensor 200 connected to the controller 170. The temperature senor 200 may be mounted to the device and directly wired to the controller 170, or may be remotely mounted and wireless connected to the controller 170. The temperature sensor 200 senses an ambient temperature in the room, where the user is viewing the program.

In accordance with the invention, the controller 170 will periodically receive temperature readings from the temperature sensor 200 and classify the temperature readings into one of several categories. For example, cold (temp<10 C); cool (10 C<temp<15 C); normal (15 C<temp<20 C); warm (20 C<temp<25 C); and hot (25 C<temp).

Based upon the temperature reading, the controller 170 will automatically set at least one of the video and audio parameters. Therefore, one or more of the video and audio parameters can change, depending upon the ambient temperature, without an action, e.g. key input, by the user. This embodiment, would allow the volume to be automatically set louder and warmer colors to be displayed during cooler temperatures. Conversely, the arrangement would allow for softer audio to be output and cooler colors to be displayed in warmer temperatures. As in the previous embodiments, the video and audio parameters could be factory preset, and later adjusted and replaced by the user, via an OSD menu.

Instead of a temperature sensor, the device could also include a user input to indicate the user's perceived temperature. The input could be via an OSD menu or via a hotkey on the remote controller 700. By this arrangement, the user would indicate their personal perceived temperature, e.g. “I feel cold”, “I feel warm”, etc. The perceived temperature input would be used by the controller 170 to adjust one or more of the video/audio parameters to factory preset settings, or user preset settings.

Another alternative embodiment of the present invention also provides for the automatic setting of at least one of the video parameters and audio parameters. In this embodiment, the program received by the device is a digital program including digital video data, digital audio data, and digital supplemental data. The digital supplemental data typically includes information concerning the program (e.g. title, duration, year of production, summary, genre, actors, close captioning, scene specific information, etc.)

By extracting the genre information from the supplemental data, the controller 170 can automatically select the most appropriate video/audio-settings for the genre type. For example, if the supplemental data indicated a concert, the controller 170 would automatically select the factory preset (or user preset) video and audio parameters associated with concert-type programs. In this arrangement, there would be no need for the user to press the Concert hotkey 712. The controller 170 would automatically select the concert presentation mode for the device based upon the supplemental data accompanying the program.

Another alternative embodiment also involves the supplemental data accompanying the program. If the supplemental data includes scene specific data, that scene specific data can be used to adjust the video/audio parameters during viewing of the program. For example, if the program includes a nighttime scene, and the supplemental data indicates such, the video and audio parameters could be adjusted to optimize the viewing of the nighttime scene. After the nighttime scene ends, the video/audio parameters would be restored back to the prior settings.

This last embodiment would allow a user to fine-tune the device to optimize the viewing of certain difficult to reproduce scenes for their particular display device. Typically, some display devices have difficult in displaying nighttime or rainy scenes, such as black pixelation abnormalities being formed in the darkest areas on the display. By setting the device such that nighttime or rainy scenes are increased in brightness and sharpness, it would be possible to quickly and automatically improve the viewing of those particular scenes, without changing the default settings for the remaining other scenes of the program. Other scenes, which could be separately adjusted, might include sunny scenes, snowy scenes, cloudy scenes, etc.

The video and audio settings for particular scenes could be factory preset, and later adjusted by the user using an OSD menu, as illustrated in FIG. 8 or FIG. 8a. The only difference being the replacement of the genre headings (Movie, Concert, etc.) with the scene headings (nighttime, rainy, sunny, etc.)

The video and audio output would be automatically adjusted by the device each time the supplemental data indicated the exhibition of such a scene. In other words, the video/audio output of the device could automatically change multiple times during a single program, without any user input (e.g. no need to press a hotkey).

The present invention can be physically incorporated into a casing of TV, monitor, projector, or similar type display device. Alternatively, the present invention can be incorporated into a device for supplying signals to a display device, such as a personal video recorder (PVR), satellite decoding box, cable decoder box, HDTV decoder box, or any other type of program receiver, typically connected to an audio receiver and display device.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A processing device comprising:
a receiver to receive a program;
a video signal processor to process a video signal of the program;
an audio signal processor to process an audio signal of the program;
a user interface to receive a user's command; and
a controller to control the video signal processor and the audio signal processor according to the user's command so that both the video signal and the audio signal are adjusted based upon a single user command.

2. The processing device of claim 1, further comprising:
a display to display the processed video signal; and
at least one speaker to output the processed audio signal.

3. The processing device of claim 1, wherein the user's command indicates a genre of the program.

4. The processing device of claim 3, wherein the genre is selected from news, sports, movie, video game, concert and normal.

5. The processing device of claim 1, wherein the user's command indicates a mood of the user.

6. The processing device of claim 5, wherein the user's mood is selected from angry, sad, calm, happy, tired, and bored.

7. The processing device of claim 1, wherein the user's command indicates the user's perceived temperature.

8. The processing device of claim 7, wherein the user's perceived temperature is selected from hot, warm, comfortable, cool, and cold.

9. The processing device of claim 1, wherein the user's command is inputted by pressing a key on a remote controller.

10. The processing device of claim 1, wherein the user's command is inputted by selecting an item in an on-screen menu.

11. A processing device comprising:
a receiver to receive a program;
a video signal processor to process a video signal of the program;
an audio signal processor to process an audio signal of the program;
a controller to control the video signal processor and the audio signal processor; and
a temperature sensor connected to said controller, wherein said controller controls the video signal processor and the audio signal processor according to an output of the temperature sensor so that at least one of the video signal and the audio signal is adjusted.

12. The processing device of claim 11, wherein both of the video signal and the audio signal are adjusted based upon the output of the temperature sensor.

13. The processing device of claim 11, further comprising:
a display to display the processed video signal; and
at least one speaker to output the processed audio signal.

14. A processing device comprising:
a receiver to receive a program;
a video signal processor to process a video signal of the program;
an audio signal processor to process an audio signal of the program; and
a controller to control the video signal processor and the audio signal processor, wherein said receiver extracts a genre identification from data information associated with the program, and wherein said controller controls the video signal processor and the audio signal processor according to the genre identification so that at least one of the video signal and the audio signal is adjusted.

15. The processing device of claim 14, wherein both of the video signal and the audio signal are adjusted based upon the genre of the program.

16. The processing device of claim 14, wherein the genre identification indicates at least one of news, sports, movie, video game, concert and normal.

17. The processing device of claim 14, further comprising:
a display to display the processed video signal; and
at least one speaker to output the processed audio signal.

18. A processing device comprising:
a receiver to receive a program;
a video signal processor to process a video signal of the program;
an audio signal processor to process an audio signal of the program; and
a controller to control the video signal processor and the audio signal processor, wherein said receiver extracts information regarding a scene's environment from data information associated with the program, and wherein said controller controls at least one of the video signal processor and the audio signal processor according to the environment of the scene of the program, so that the at least one of the video signal and the audio signal is adjusted.

19. The processing device of claim 18, wherein both of the video signal and the audio signal are adjusted based upon the environment of the scene.

20. The processing device of claim 18, wherein the environment of the scene is at least one of sunny, night-time, raining, snowing, and cloudy.

21. The processing device of claim 18, wherein the video signal and audio signal may be adjusted multiple times during a single program, according to the changing environments of the scenes in the program.

22. The processing device of claim 18, further comprising:
a display to display the processed video signal; and
at least one speaker to output the processed audio signal.

23. A method for controlling a processing device, comprising:
simultaneously setting a video output parameter and an audio output parameter to preset adjustment values based upon a single selected item.

24. The method of claim 23, wherein the single selected item is selected by pressing a key input on a remote controller.

25. The method of claim 23, wherein the single selected item is selected by choosing an item in an on-screen menu.

26. The method of claim 23, wherein the single selected item is selected by a temperature in an area near the processing device.

27. The method of claim 23, wherein the single selected item is selected by a genre of the video program.

28. The method of claim 27, wherein the genre information is determined by data information accompanying the program.

29. The method of claim 27, wherein the genre information is selected by a user from a list of genre types.

30. The method of claim 23, wherein the single selected item is selected from a list of human moods.
